(19) United States
(12) Patent Application Publication
(10) Pub. No.: US 2010/0205135 A1
(43) Pub. Date: Aug. 12, 2010

(54) DETERMINING BEST MATCH AMONG A PLURALITY OF PATTERN RULES USING WILDCARDS WITH A TEXT STRING

(75) Inventor: Subrahmanyam ONGOLE, CUPERTINO, CA (US)

Correspondence Address: PATENTRY, P.O. BOX 151616, SAN RAFAEL, CA, 94915-1616, US

(73) Assignee: BARRACUDA INC., CAMPBELL, CA (US)

(21) Appl. No.: 12/043,954

(22) Filed: Mar. 7, 2008

(51) Int. Cl. G06N 5/02

(52) U.S. Cl. 706/48

(57) ABSTRACT

A method for creating and operating a database for determining the best match of a plurality of rules comprising wildcards and character strings with an input text string.

### BACKGROUND OF THE INVENTION

Pattern expressions allow wildcards to match zero, one, or more than one characters. Rules which apply policies (which include setting values or have consequences) may use pattern expressions to enable their applicability to a wider range of inputs than rules which require a specific text string. In some cases these policies may contradict or conflict even though the rules that apply or set them may equally evaluate as true in Boolean logic. Yet for every rule, there is commonly expressed a need to provide for an exception.

Thus it can be appreciated that what is needed is a way to determine of a plurality of rules, which one is most true or more reasonably, has the best fit or best match.

### SUMMARY OF THE INVENTION

In the present patent application rules are either unique rules or pattern rules and are comprised of keys and policies. The keys of unique rules do not contain wildcards and therefore compared to an input text string, either match or don't match. The keys of pattern rules contain at least one wildcard. An input text string may be matched by zero, one, or a plurality of pattern rules. Pattern rules may include conflicting policies.

Content switching and Web Firewall rules are applications of pattern rules which consist of variable length keys with one or more wild card characters. It may be impractical, inefficient or uneconomical to search these rules in a sequential manner. An embodiment of the present invention is a process for finding the best matching rule for a given input string by simultaneously matching all the keys. The method of the invention supports up to one wild card character anywhere in the rule. The keys themselves could be partially matching with other keys. We also define what a best match is in the following sections. A rule as defined in the present patent application comprises a key comprising a text string and a policy. A rule that doesn't consist of any wild card character is defined to be a Unique Rule. A rule that contains at least one wildcard is herein defined as a Pattern Rule. The present patent application applies to rules which contain zero or one wildcard. A wildcard is defined to match zero, one, or a plurality of any characters. Asterisk, star, or * are notations for a wildcard but the notation is for understanding and not limiting the scope of the invention. The part of the rule preceding ‘*’ is Prefix Key and the part of the rule succeeding ‘*’ is Suffix Key. The invention is the method of determining the best matching rule by matching the text string with the longest Prefix Key and as a tie breaker among equally long Prefix Keys, the longest Suffix Key.

In a mode of the invention, a process for creating and operating a database of rules comprises inserting Prefix Keys and Unique Keys from all the rules in a Prefix tree which is based on a variant of Ptrie implementation. There could be more than one rule with the same Prefix Key, but with different Suffix Keys. Such a Key node in the Prefix tree consists of another Ptrie of Suffix Keys. The keys in a Suffix tree are matched right to left on the input string.

In a mode of the invention, a process for applying the database of rules to an input text string comprises matching the keys left to right on the input string. If a given input string matches a specific Prefix key but does not match any of the corresponding Suffix Keys, the process finds the next best matching Prefix Key and the process continues until it finds a matching rule or until all the rules in the database have been searched.

Definition List 1

| Term | Definition |
|---|---|
| Rule | A text string read from left to right |
| Policy | A state, action, or value; set or applied |
| Default rule | A rule that matches any text string |
| Wildcard e.g. * | A wildcard is defined to match zero, one, |
| | or a plurality of any characters. |
| Unique rule | An exact string without any wildcard |
| Pattern rule | A rule that contains at least one wildcard |
| | is herein defined as a Pattern Rule |
| Key | One or more characters |
| Prefix key | The part of a rule preceding a wildcard |
| Suffix key | The part of a rule succeeding a wildcard |
| Prefix rule | A rule having a wildcard and a prefix |
| Suffix rule | A rule having a wildcard and a suffix |
| Prefix*suffix rule | A rule having both a prefix and suffix |
| Best match | matching a text string with the longest |
| | Prefix Key and among equally long Prefix |
| | Keys, the longest Suffix Key |
| Successor rule | Includes first text string of ur-rule and a |
| | second text string |
| Ur rule | A pattern rule partially matching at least |
| | one successor rule. |

The present invention provides a method for generating and operating a hierarchical database of rules which may include wildcards, a precedence among rules which evaluate as true but have contradictory policies or consequences, and a way to determine the best match (fit) among rules which depend on wildcards to match an expression. Even though the rules may be evaluated in any order or in parallel, the use of precedence here has the meaning of one rule having dominance, highest strength, or trumping the policy of other rules.

Among rules that evaluate as true in matching an expression yet have contradictory policies, the present invention specifies that a unique rule having no wildcard takes precedence over a class of non-unique rules (pattern rules) having a wildcard; a class of pattern rules having both a prefix key and a suffix key takes precedence over a class of pattern rules having only a prefix key; a class of pattern rules having only a prefix key takes precedence over a class of pattern rules having only a suffix key, and a class of pattern rules having only a suffix key takes precedence over a default rule.

Within the classes of rules specified above, the rule having the longest matching key is determined to be the best match or best fit and any policy or consequence which contradicts it is overridden. Within the specific class of pattern rules having both a prefix key and a suffix key, the rule matching the input text string with the longest prefix key is determined to be the best match and, as a tie-breaker, among a plurality of rules with equally long matching prefix keys, the rule matching the input text string with the longest suffix key is determined to be the best match.

### BRIEF DESCRIPTION OF THE FIGURES

FIG. 1 is a Venn diagram of classes rules which may include sets or subsets.

FIG. 2 is a hierarchical pyramid of classes of rules and their relative precedence.

FIG. 3 is a flowchart of a method for testing rules and setting policies or consequences.

FIG. 4 is a p-tree diagram of rules organized as a variant of Ptrie in prefix configuration.

FIG. 5 is a listing of pseudocode illustrating a method of creating a Ptrie variant database.

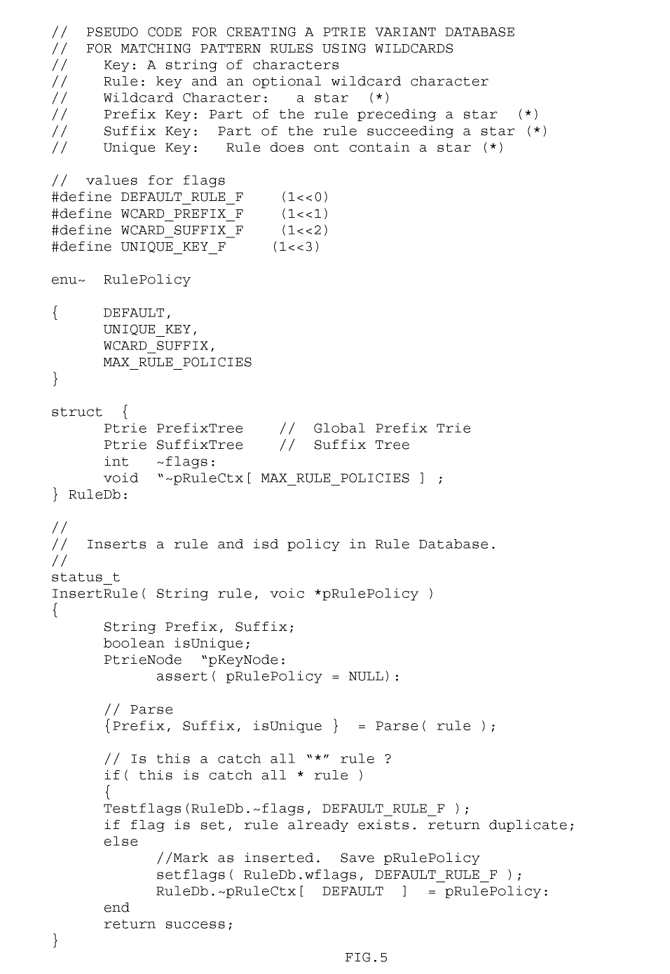

FIG. 6 is a block diagram of a computing system embodiment of the invention

### DETAILED DISCLOSURE OF EMBODIMENTS OF THE INVENTION

It is the observation of the inventor that while use of pure Boolean logic expression evaluate to True or False, the employment of pattern expressions in rules allows the use of wildcards to match zero, one, or more characters. This allows some rules to be very broad and other rules to be quite narrow. A rule expressed as a wildcard may be used to set a default policy with the intent that any other rule may be used to override it. It is reasonable to consider that a rule with no wildcards at all, that is matching an text string exactly would be intended to override the default policy set by a rule having a wildcard. It is the objective of the present invention to resolve the setting of policies of two rules which conflict in one or more effects.

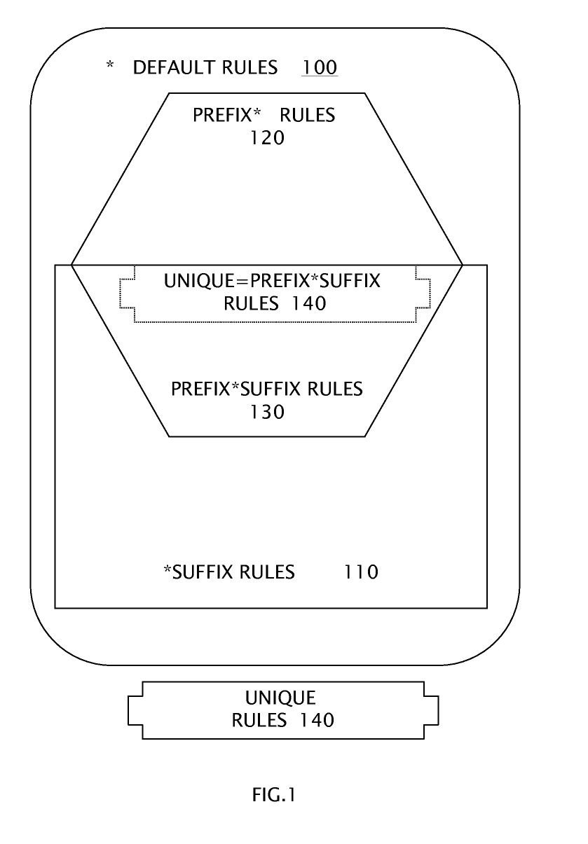

Referring now to the figures, a Venn diagram in FIG. 1 illustrates several classes of rules which comprise sets, subsets, and intersecting sets. The universe of rules is depicted as the set 140 unique rules and the set 100 which is comprised of default rules and all rules which contain wildcards. A hexagon 120 represents prefix rules which comprise a prefix key preceding a wildcard. It is conventional notation to represent a wildcard as a star, asterisk, or *. A rectangle represents suffix rules which comprise a suffix key succeeding a *. Preceding and succeeding are used with respect to reading left to right. A trapezoid 130 represents prefix*suffix rules which are the intersection of prefix rules and suffix rules having a prefix, a star, and a suffix. A twelve sided FIG. 140 is shown for unique rules. However, the twelve sided FIG. 140 is shown with dotted lines within the trapezoid even though unique rules have no star because, a text string may include a prefix key which would be matched by a prefix rule and it may include a suffix which would be matched by a suffix rule and it may include both or neither. A certain text string may trigger a unique rule as well as every rule containing a wildcard. A better illustration is that of a pyramid.

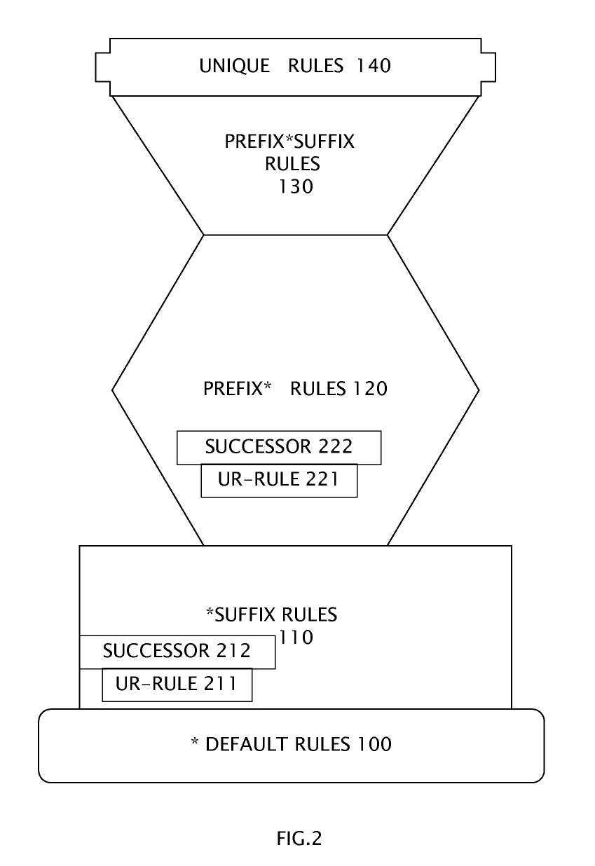

Referring now to FIG. 2, a pyramid of variously shaped polygons is shown stacked in their relative precedence. Default rules 100 are at the bottom and only control policies not set by any rule above it in the stack. Unique rules 140 are at the top of the stack and policies set by a unique rule may not be altered by any other rule. In the middle are three classes of rules having wildcards which dominate the classes below them but are in turn dominated by the upper classes. The hexagon prefix rules 120 is shown above the rectangle suffix rules 110 because any policy set by a prefix rule comprised of a prefix key preceding a star, may not be changed by a suffix rule comprised of a suffix key succeeding a star. The hexagon prefix rules 120 is shown below the trapezoid prefix*suffix rules 130 because even if both rules evaluate as true policies set by the prefix*suffix rule are dominant. Within prefix rules 120 and suffix rules 110 are ur-rules and successor rules. A successor rule 222 of prefix rules begins on the left with the same character string as its ur-rule 221 but where the ur-rule has its star, the successor rule has a second character string. A successor rule 212 of suffix rules begins on the right with the same character string as its ur-rule 211 but reading right to left, where the ur-rule has its star, the successor rule has a second character string. If a text string matches both an ur-rule and its successor rule, the successor rules has more characters matching and is considered for the purpose of setting policies to be the better fit or better match. An ur-rule partially matches at least one successor rule. Within the present invention an ur-rule is defined to pattern match a successor rule. A “string*” partially matches a “longerstring*”. A successor rule matches the pattern of an ur-rule. A successor rule takes precedence over or dominates its ur-rule(s).

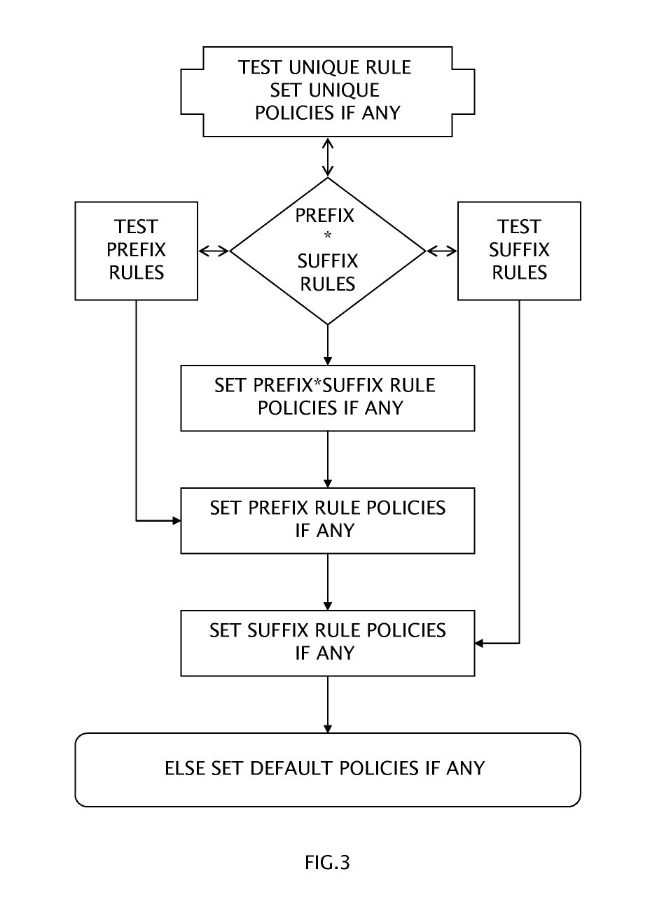

In an embodiment of the present invention, illustrated in FIG. 3, three processes evaluate a text string by testing unique rules, prefix rules, and suffix rules. These testing processes can be in any order or in parallel. In an embodiment, unique and prefix rules may be tested in parallel followed by suffix rules. Testing can be done by conventional means known to those skilled in the art including but not limited to ptries, hashing, pattern expression scripting, and binary search. In an embodiment, if a unique rule is matched the policies set by the unique rule are set and further processing may be terminated if there are no other policies to be set. If there remain any, it is determined if there is an intersection of prefix rules and suffix rules which match and policies of a prefix*suffix rule are set. If there remain further policies matching continues for prefix rules followed by suffix rules, and default rules. As soon as all policies are set, the process may be terminated without further matching.

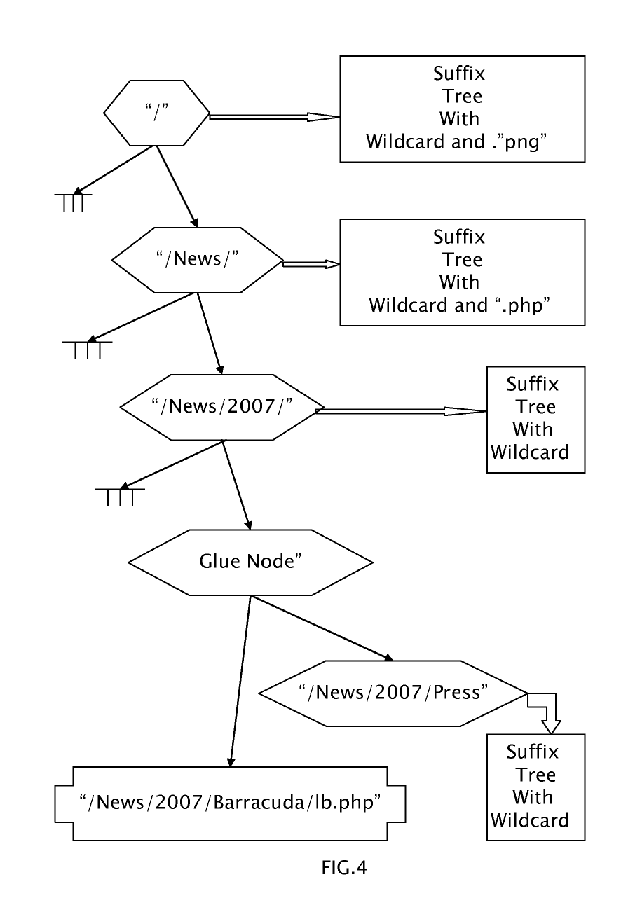

In an embodiment of the present invention, illustrated in FIG. 4, a variant ptrie of rules is traversed, evaluating a tree of unique keys and prefix keys. If a node is encountered, it specifies if it is a prefix or a unique key which terminates the process. If it is a prefix it specifies whether or not there are one or more suffixes to match.

It may be appreciated that testing and evaluating rules in other order is less optimum yet we disclose setting by lower classes and subsequent resetting of values by the upper classes for completeness.

The essential embodiment of the present invention is disclosed as a system for generating and operating a hierarchical database of rules controlling one or more policies comprising the following steps:
selecting a plurality of rules which control setting a policy;
selecting a rule which does not contain a wildcard and categorizing it as a unique rule;
selecting a rule which comprises a string of characters terminated with a wildcard and categorizing it as a prefix rule;
selecting a rule which comprises a string of characters initiated with a wildcard and categorizing it as a suffix rule;
selecting a rule which comprises a string of characters preceding and following a wildcard and categorizing it as a prefix*suffix rule.

A key process of the present invention is a method of determining a best match for an input text string among a plurality of rules comprising the following steps:
comparing all unique rules with the input text string and selecting a rule having an exact match;
comparing all pattern rules having a matching prefix key and a matching suffix key and selecting a rule having the longest prefix key and among rules have equal length prefix keys, that having the longest suffix key;
comparing all pattern rules having a matching prefix key and selecting a rule having the longest prefix key; and
comparing all pattern rules having a matching suffix key and selecting a rule having the longest suffix key;
   wherein a prefix key is a string of characters preceding a wildcard (*), and a suffix key is a string of characters succeeding a wildcard (*).

The sequence of comparing and selecting is not an essential aspect of the present invention allowing parallel processing or asynchronous processing of rules. What is essential is the relative dominance of rules in applying policies which for efficiency is the following precedence: unique rules taking precedence over pattern rules, a pattern rule having a prefix key, a wildcard, and a suffix key taking precedence over pattern rules having only a prefix key, a pattern rule having only a prefix key taking precedence over pattern rules having only a suffix key, and a suffix rule taking precedence over a default rule having only a wildcard. A successor rule takes precedence over its ur-rules.

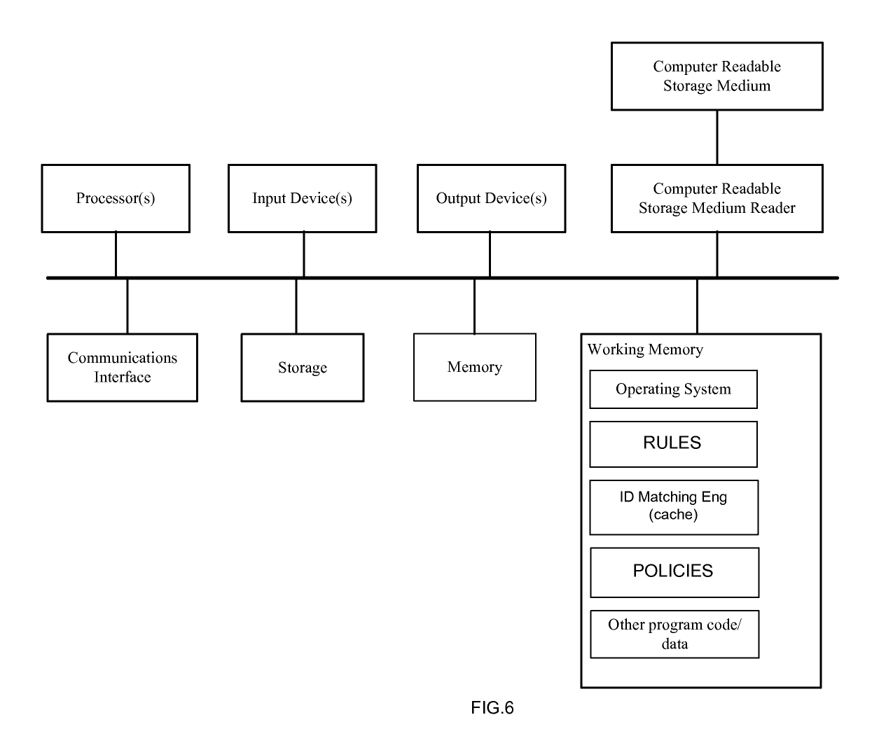

The FIG. 6 flow diagram illustrates a computing system embodiment that may comprise a computer program embodied on a computer usable medium adapted to control the movement of network traffic. While other alternatives may be utilized or some combination, it will be presumed for clarity sake that components of the present invention are implemented in hardware, software or some combination by one or more computing systems consistent therewith, unless otherwise indicated or the context clearly indicates otherwise.

Computing system comprises components coupled via one or more communication channels (e.g. bus) including one or more general or special purpose processors , such as a Pentium®, Centrino®, Power PC®, digital signal processor (“DSP”), and so on. System components also include one or more input devices (such as a mouse, keyboard, microphone, pen, and so on), and one or more output devices , such as a suitable display, speakers, actuators, and so on, in accordance with a particular application.

System also includes a computer readable storage media reader coupled to a computer readable storage medium , such as a storage/memory device or hard or removable storage/memory media; such devices or media are further indicated separately as storage and memory , which may include but are not limited to hard disk variants, floppy/compact disk variants, digital versatile disk (“DVD”) variants, smart cards, partially or fully hardened removable media, read only memory, random access memory, cache memory, and so on or some combination, in accordance with the requirements of a particular implementation. One or more suitable communication interfaces may also be included, such as a modem, DSL, infrared, RF or other suitable transceiver(s), and so on or some combination, for providing inter-device communication directly or via one or more suitable private or public networks or other components that may include but are not limited to those already discussed.

Working memory further includes operating system (“OS”), and may include one or more of the remaining illustrated components in accordance with one or more of a particular device, examples provided herein for illustrative purposes, or the requirements of a particular application. Working memory of one or more devices may also include other program code or data (“information”), which may similarly be stored or loaded therein during use.

The particular OS may vary in accordance with a particular device, features or other aspects in accordance with a particular application, e.g., using Windows, WindowsCE, Mac, Linux, Unix, a proprietary OS, and so on or some combination and may be implemented as a real or virtual OS. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for conducting but not limited to the examples discussed elsewhere herein. Other program code/data may, for example, include one or more of security, compression, synchronization, backup systems, groupware, networking, or browsing, client or other transmission mechanism code, and so on, including but not limited to those discussed elsewhere herein.

When implemented in software, one or more of system components may be communicated transitionally or more persistently from local or remote storage to memory (SRAM, cache memory, and so on or some combination) for execution, or another suitable mechanism may be utilized, and one or more component portions may be implemented in compiled or interpretive form. Input, intermediate or resulting data or functional elements may further reside more transitionally or more persistently in a storage media, cache or other volatile or non-volatile memory, (e.g., storage device or memory) in accordance with the requirements of a particular implementation.

A preferred embodiment of the present invention is an article of manufacture comprising a computer usable medium tangibly embodying a computer program adapted to control a processor according to the methods of the claims below.

### CONCLUSION

The present invention is distinguished from conventional rule processing by enabling the rules to be evaluated in parallel, in asynchronous processes, top down, bottom up, or in any arbitrary order. Conventional rules require a sequence to be specified by the rulemakers to prevent deadlock or data corruption. In the present invention the process of adding the rules to the database allows them to be analyzed for their relative precedence in controlling policies. The present invention adapts the method of ptries to handle rules which may be unique and which may contain wildcards enabling in parallelism in testing a plurality of rules.

Even though a plurality of rules with contradictory policies may each match a input text string due to the use of wildcards, the present invention determines which rule has the best match and thus resolves potential or apparent conflicting policies. The present invention extends the use of ptries to rules containing wildcards. An embodiment of the present invention is pattern matching or partially matching two rules related by wildcards as well as an input text string with a plurality of rules each having a wildcard.

What is claimed is:

1. A method comprising the following processes:
selecting a pattern rule which comprises a prefix key comprising a string of characters preceding a wildcard and categorizing it as a prefix rule;
comparing an input text string with all pattern rules having a matching prefix key and selecting a rule having the longest prefix key; and
setting the policy of the rule.

2. The method of claim one further comprising the processes:
selecting a pattern rule which comprises a suffix key comprising a string of characters succeeding a wildcard and categorizing it as a suffix rule;
comparing an input text string with all pattern rules having a matching suffix key and selecting a rule having the longest suffix key; and
setting the policy of the rule.

3. The method of claim two further comprising the processes:
selecting a rule which does not contain a wildcard and categorizing it as a unique rule;
comparing all unique rules with an input text string and selecting a rule having an exact match;
setting a policy specified by unique rules which match; and
setting a default policy specified by default rules.

4. An article of manufacture comprising a computer usable medium tangibly embodying a program product adapted to control a computing system having encoded instructions to compare prefix strings and suffix strings in rules with input text.
